(19) United States
(12) Patent Application Publication
(10) Pub. No.: US 2005/0023830 A1
(43) Pub. Date: Feb. 3, 2005

(54) Outlet joint of flexible tube

(76) Inventor: Chiu Chih Chung, Chunghua Hsien (TW)

Correspondence Address: Chiu Chih Chung, 235 Chung-Ho, Box 8-24, Taipei, TW

(21) Appl. No.: 10/628,796

(22) Filed: Jul. 29, 2003

(51) Int. Cl. F16L 33/00; F16L 47/00

(52) U.S. Cl. 285/255

(57) ABSTRACT

An outlet joint of a flexible tube has a joint which including a sleeve for locking one end of the flexible tube body; a water stop block engaged in a lower end of the internal tube, and a water stop sleeve tightly engaged to the water stop block. Two ends of an inner surface of the sleeve have inner threads. The water stop block is a tapered ring; and an outer surface of the water stop block has an annular recess for receiving a washer. A top surface of the water stop sleeve has a receiving groove. One end of the inner surface of the receiving groove is correspondent to the outer surface of the water stop block. Thereby, by above structure, the water stop block is tightly engaged to the water stop sleeve so that the outlet joint can suffer from a great water pressure.

### FIELD OF THE INVENTION

The present invention relates to outlet joints, and particularly to an outlet joint of a flexible tube which has a tapered water stop block and a water stop sleeve having a tapered inner groove. By the tight engagement of the water stop block and the water stop sleeve, outlet joint can suffer from a great water pressure.

### BACKGROUND OF THE INVENTION

Referring to FIG. 1, a conventional outlet joint of a flexible tube is illustrated. The outlet joint includes a flexible tube body 1 and a joint 5 at an end portion of the flexible tube body 1. A lower end of the joint 5 is screwed with a sleeve 6. A washer 61 is installed between the sleeve 6 and the joint 5.

In use, the prior art outlet joint of a flexible tube can not present a required effect. Only one washer 61 serves to stop water between the joint 5 and the sleeve 6. After the sleeve 6 is locked into the joint 5, if the locking force is not uniform, some water possibly drains out. Especially, the combination of the joint 5 and the flexible tube body 1 is mainly by locking a stud 51 to the lateral surface of the joint 5. A lower end thereof faces to the lateral surface of the flexible tube body 1 so as to have a fixing effect. However, for a longer time, the stud 51 will loose so that the flexible tube body 1 will fall down or the combination portion will vibrate or loose. Moreover, the wall of the flexible tube body 1 is not strengthened. It easily collapses due to the pressure of the stud 51 so that the stud 51 will become loose or fall down easily.

### SUMMARY OF THE INVENTION

Accordingly, the primary object of the present invention is to provide an outlet joint of a flexible tube. The joint includes a sleeve for locking one end of the flexible tube body; a water stop block engaged in a lower end of the internal tube, and a water stop sleeve tightly engaged to the water stop block. Two ends of an inner surface of the sleeve have inner threads. The water stop block is a tapered ring; and an outer surface of the water stop block has an annular recess for receiving a washer. A top surface of the water stop sleeve has a receiving groove. One end of the inner surface of the receiving groove is correspondent to the outer surface of the water stop block for aligning the water stop block to the water stop sleeve as the water stop sleeve is engaged with the water stop block. Thereby, by above structure, the water stop block is tightly engaged to the water stop sleeve so that the outlet joint can suffer from a great water pressure.

The various objects and advantages of the present invention will be more readily understood from the following detailed description when read in conjunction with the appended drawing.

### BRIEF DESCRIPTION OF THE DRAWINGS

FIG. 1 is a plane schematic view about a prior art drain-proof washer.

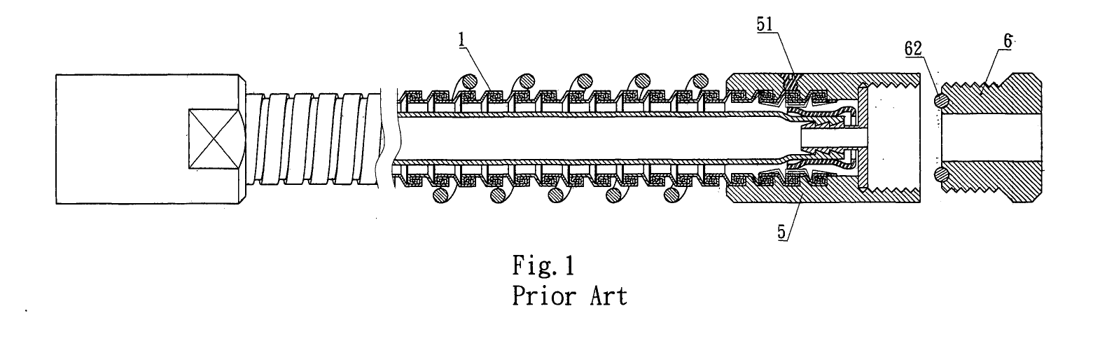

FIG. 2 is an exploded perspective view of the present invention.

FIG. 3 is an assembled perspective view of the present invention.

FIG. 4 is a plane cross sectional view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

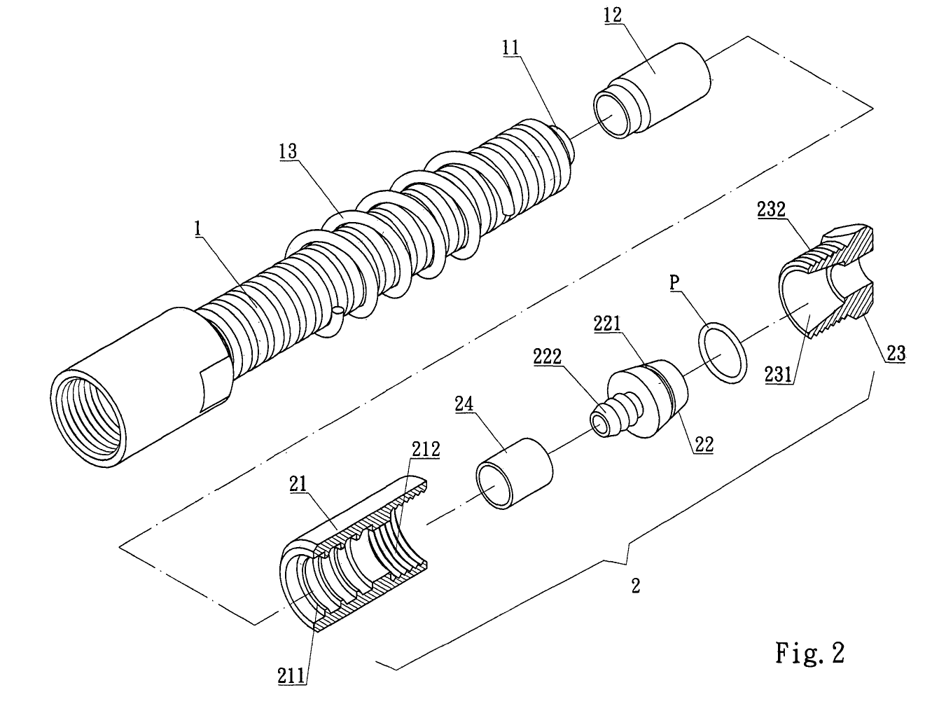

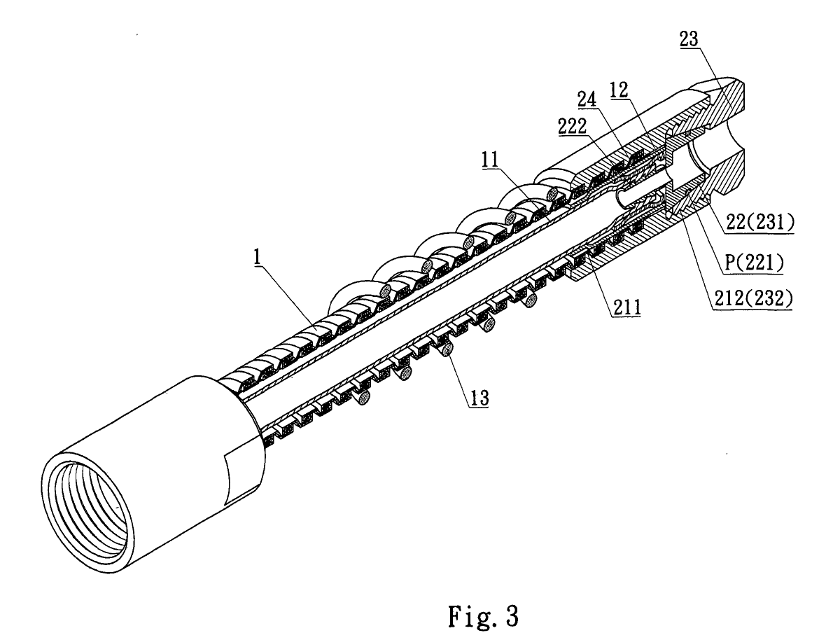

With reference to FIGS. 2, and 3, the outlet joint of a flexible tube of the present invention includes a flexible tube body 1, and a joint 2 assembled to the end portion of the body.

The inner side of the flexible tube body 1 has an internal tube 11. A tightening ring 12 is installed between the internal tube 11 and the flexible tube body 1. A protecting ring 13 encloses the flexible tube body 1.

The joint 2 includes a sleeve 21 for locking one end of the flexible tube body; a water stop block 22 engaged in a lower end of the internal tube 11, and a water stop sleeve 23 tightly engaged to the water stop block 22. Furthermore, two ends of the inner surface of the sleeve 21 have inner threads 211/212 so that one end thereof can be screwed to the end portion of the flexible tube body 1 and another end thereof is locked by the water stop sleeve 23.

The water stop block 22 is a tapered ring. An outer surface of the water stop block 22 has an annular recess 221 for receiving a washer P. A screw rod 222 protruded from a top of the water stop block 22 which can be received in the internal tube 11.

A top surface of the water stop sleeve 23 has a receiving groove 231. One end of the inner surface of the receiving groove 231 is correspondent to the outer surface of the water stop block 22 for aligning the water stop block 22 to the water stop sleeve 23 as the water stop sleeve 23 is engaged with the water stop block 22. An outer surface of the water stop sleeve 23 is formed with external threads 232 which can be locked into one of the sleeve 21 so that after the water stop sleeve 23 is locked, the sleeve 21 is between the sleeve 21 and the inner tube 11. A thin metal ring 24 is placed between the water stop sleeve 23 and the internal tube 11 for drain-proof.

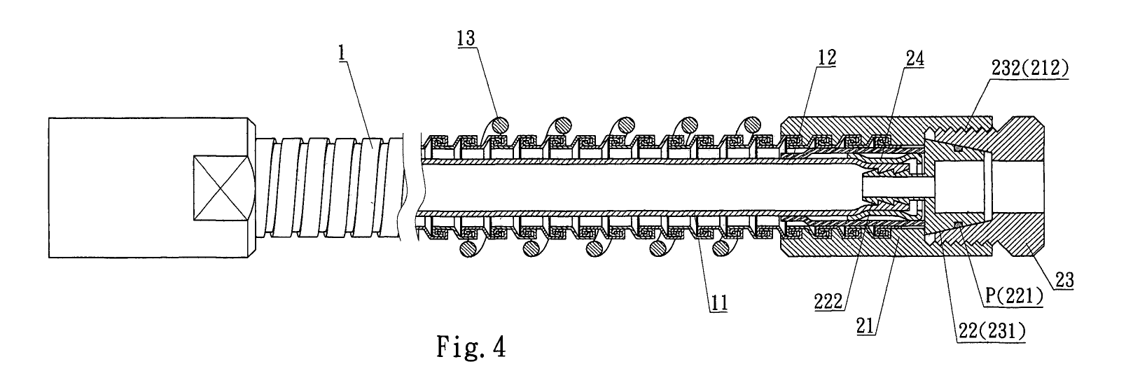

In assembly, as shown in FIG. 4, the flexible tube body 1 is assembled with the internal tube 11 in advance. A lower end of the internal tube 11 is engaged to the water stop block 22. The water stop block 22 is received into the water stop sleeve 23 so that the external thread 232 of the water stop sleeve 23 is locked to the internal thread 212 at the lower end of the sleeve 21. By engaging the water stop sleeve 23 to the water stop block 22, the centers of the two can be aligned automatically and moreover, the washer P is used to stop water so that the water stop block 22 is tightly engaged to the water stop sleeve 23 which can suffer from a large water pressure.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. (Cancelled)

2. An outlet joint of a flexible tube comprising:
a flexible tube body; an inner side of the flexible tube body having an internal tube; a tightening ring being installed between the internal tube and the flexible tube body; a protecting ring enclosing the flexible tube body;
a joint including a sleeve for locking one end of the flexible tube body; a water stop block engaged in a lower end of the internal tube, and a water stop sleeve tightly engaged to the water stop block;
wherein two ends of an inner surface of the sleeve have inner threads so that one end thereof is screwed to an end portion of the flexible tube body and another end thereof is locked by the water stop sleeve;
wherein the water stop block has a tapered prolong ring; an outer surface of the tapered prolong ring of the water stop block has an annular recess for receiving a washer; a screw rod protruded from a top of the water stop block which is received in the internal tube;
wherein a top surface of the water stop sleeve has a receiving groove; one end of the inner surface of the receiving groove is correspondent to the outer surface of the water stop block for aligning the water stop block to the water stop sleeve as the water stop sleeve is engaged with the water stop block; an outer surface of the water stop sleeve is formed with external thread which can be locked into one of the sleeve so that after the water stop sleeve is locked, the sleeve is between the sleeve and the inner tube; a thin metal ring is placed between the water stop sleeve and the internal tube for drain-proof;
thereby, by above structure, the water stop block is tightly engaged to the water stop sleeve so that the outlet joint can suffer from a great water pressure.
